(19) United States
(12) Patent Application Publication
(10) Pub. No.: US 2026/0238136 A1
(43) Pub. Date: Aug. 13, 2026

(54) ELECTRONIC DEVICE FOR PROVIDING POWER TO EXTERNAL DEVICE, AND OPERATING METHOD THEREOF

(71) Applicant: Samsung Electronics Co., Ltd., Suwon-si (KR)

(72) Inventor: Jaedeok CHA, Suwon-si (KR)

(21) Appl. No.: 19/637,296

(22) Filed: Apr. 2, 2026

Related U.S. Application Data
(63) Continuation of application No. PCT/KR2024/015424, filed on Oct. 11, 2024.

(30) Foreign Application Priority Data
Oct. 23, 2023 (KR) 10-2023-0141817
Jan. 4, 2024 (KR) 10-2024-0001390

(51) Int. Cl. H02M 3/335; H02M 1/00

(52) U.S. Cl. CPC H02M 3/33592; H02M 1/0045

(57) ABSTRACT

An electronic device for providing power to an external device is provided. The electronic device includes a power conversion circuit configured to convert power provided from an external power source, a connector configured to be connected to the external device to provide power provided from the power conversion circuit to the external device, a resistor configured to detect whether the external device is connected through the connector, a first circuit electrically connected to a first end of the resistor to supply a bias voltage to the resistor based on the power provided from the external power source, a pulse width modulation (PWM) circuit configured to control PWM of a first switch electrically connected to a primary coil of a transformer included in the power conversion circuit, and a second circuit electrically connected to a second end of the resistor to provide a signal to the PWM circuit based on connection or disconnection with the external device through the connector, wherein the first circuit includes a first capacitor for capacitor isolation and voltage distribution at both ends of the first circuit, and the second circuit includes a second capacitor for capacitor isolation and voltage distribution at both ends of the second circuit.

### CROSS-REFERENCE TO RELATED APPLICATION(S)

This application is a continuation application, claiming priority under 35 U.S.C. § 365(c), of an International application No. PCT/KR 2024/015424, filed on Oct. 11, 2024, which is based on and claims the benefit of a Korean patent application number 10-2023-0141817, filed on Oct. 23, 2023, in the Ministry of Intellectual Property (MOIP), and of a Korean patent application number 10-2024-0001390, filed on Jan. 4, 2024, in the Ministry of Intellectual Property (MOIP), the disclosure of each of which is incorporated by reference herein in its entirety.

### BACKGROUND

### 1. Field

The disclosure relates to an electronic device providing power to an external device and an operating method thereof.

### 2. Description of Related Art

Energy consumption has a significant impact on the environment, and focusing on the efficiency of that process makes it possible to reduce carbon emissions and save energy costs. Accordingly, this includes waste reduction and recycling, use of eco-friendly products, and consideration of product life cycles, and in particular, reducing standby power consumption of electronic products may be a very important item. Ultimately, companies should pay attention not only to efficiency in the production process but also to low-loss, high-efficiency design of products for sale. Electronic devices such as computers, set-top boxes, and televisions consume significant power even in a standby state when not actually in use, and such standby power should be managed. In other words, when the power is turned off but the alternating current (AC) plug is inserted, a small amount of current flows through the electronic device, and this current is necessary to maintain the minimum functionality of the product, but is sometimes used to actively control various operations. The sum of standby power consumption of many electronic devices may only be significant from the power plant's perspective, ultimately requiring an increase in power plants, and carbon emissions in the process of generating power become inevitable.

A power supply basically implements a low-power operation mode for no-load conditions in the Off state to reduce standby power. However, as the rated capacity of the power supply increases, standby power increases proportionally, so continuous research and development is needed to reduce this. In particular, the standby power of power delivery (PD) adapters connected to laptop type-C ports complying with recent PD specifications is already maintained below a predetermined level, but continuous idea reflection and technology development are required to achieve zero power levels of 5 mW or less.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device providing power to an external device and an operating method thereof.

Additional aspects will be set forth in part in the description which follows and, in part, will be apparent from the description, or may be learned by practice of the presented embodiments.

In accordance with an aspect of the disclosure, an electronic device configured to provide power to an external device is provided. The electronic device includes a power conversion circuit configured to convert power provided from an external power source, a connector configured to be connected to the external device to provide power provided from the power conversion circuit to the external device, a resistor configured to detect whether the external device is connected through the connector, a first circuit electrically connected to a first end of the resistor to supply a bias voltage to the resistor based on the power provided from the external power source, a pulse width modulation (PWM) circuit configured to control PWM of a first switch electrically connected to a primary coil of a transformer included in the power conversion circuit, and a second circuit electrically connected to a second end of the resistor to provide a signal to the PWM circuit based on connection or disconnection with the external device through the connector, wherein the first circuit includes a first capacitor for capacitor isolation and voltage distribution at both ends of the first circuit, and the second circuit includes a second capacitor for capacitor isolation and voltage distribution at both ends of the second circuit.

In accordance with another aspect of the disclosure, a method performed by an electronic device configured to provide power to an external device is provided. The method includes, based on receiving power from an external power source, supplying, by the electronic device, a bias voltage to a resistor configured to detect whether an external device is connected through a connector of the electronic device using a first circuit including a first capacitor for capacitor isolation and voltage distribution, wherein the first circuit is electrically connected to a first end of the resistor, based on a connection between the electronic device and the external device through the connector, providing, by the electronic device, a signal to a pulse width modulation (PWM) circuit using a second circuit including a second capacitor for capacitor isolation and voltage distribution, wherein the second circuit is electrically connected to a second end of the resistor, based on the signal provided from the second circuit, controlling, by the electronic device, PWM of a first switch electrically connected to a primary coil of a transformer included in a power conversion circuit of the electronic device using the PWM circuit, and providing, by the electronic device, power provided from the power conversion circuit to the external device through the connector.

In accordance with another aspect of the disclosure, one or more non-transitory computer-readable storage media storing one or more computer programs including computer-executable instructions that, when executed by one or more processors of an electronic device providing power to an external device individually or collectively, cause the electronic device to perform operations are provided. The operations include based on receiving power from an external power source, supplying, by the electronic device, a bias voltage to a resistor configured to detect whether an external device connected through a connector of the electronic device using a first circuit including a first capacitor for capacitor isolation and voltage distribution, wherein the first circuit is electrically connected to a first end of the resistor, based on a connection between the electronic device and the external device through the connector, providing, by the electronic device, a signal to a pulse width modulation (PWM) circuit using a second circuit including a second capacitor for capacitor isolation and voltage distribution, wherein the second circuit is electrically connected to a second end of the resistor, based on the signal provided from the second circuit, controlling, by the electronic device, PWM of a first switch electrically connected to a primary coil of a transformer included in a power conversion circuit of the electronic device using the PWM circuit, and providing, by the electronic device, power provided from the power conversion circuit to the external device through the connector.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device within a system according to an embodiment of the disclosure;

FIG. 2 is a block diagram illustrating an electronic device according to an embodiment of the disclosure;

FIG. 3 is a circuit diagram illustrating an electronic device according to an embodiment of the disclosure;

FIG. 4 is a block diagram illustrating an electronic device, according to an embodiment of the disclosure;

FIG. 5 is a circuit diagram illustrating a first circuit for capacitor isolation according to an embodiment of the disclosure;

FIG. 6 is a circuit diagram illustrating a second circuit for capacitor isolation according to an embodiment of the disclosure;

FIG. 7 is a flowchart illustrating an operating method of an electronic device according to an embodiment of the disclosure;

FIG. 8 is a graph illustrating an operation of an electronic device according to an embodiment of the disclosure;

FIGS. 9A and 9B are views illustrating an operation of an electronic device according to various embodiments of the disclosure; and

FIGS. 10A and 10B are views illustrating standby power of an electronic device according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

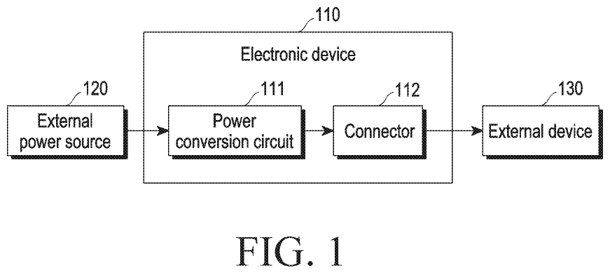

FIG. 1 is a block diagram illustrating an electronic device within a system according to an embodiment of the disclosure.

Referring to FIG. 1, according to an embodiment of the disclosure, an electronic device 110 may provide power to an external device 130. The electronic device 110 may provide power to the external device 130 based on power provided from an external power source 120. For example, the external power source 120 may be a wall outlet providing alternating current (AC) power. The external device 130 may be a device receiving direct current (DC) power. The electronic device 110 may convert AC power to DC power. For example, the electronic device 110 may be a power supply (e.g., an adapter). For example, the external device 130 may include a portable communication device (e.g., a smartphone), a computer device (e.g., a laptop), a portable multimedia device, a portable medical device, a camera, a wearable device, or a home appliance. The devices according to an embodiment of the disclosure are not limited to the above-described devices.

According to an embodiment of the disclosure, the electronic device 110 may include a power conversion circuit 111 and a connector 112. The electronic device 110 may convert AC power provided from the external power source 120 to DC power using the power conversion circuit 111. The electronic device 110 may be connected to the external device 130 through the connector 112. The electronic device 110 may provide DC power to the external device 130 through the connector 112. The electronic device 110 may provide DC power provided from the power conversion circuit 111 to the external device 130 through the connector 112.

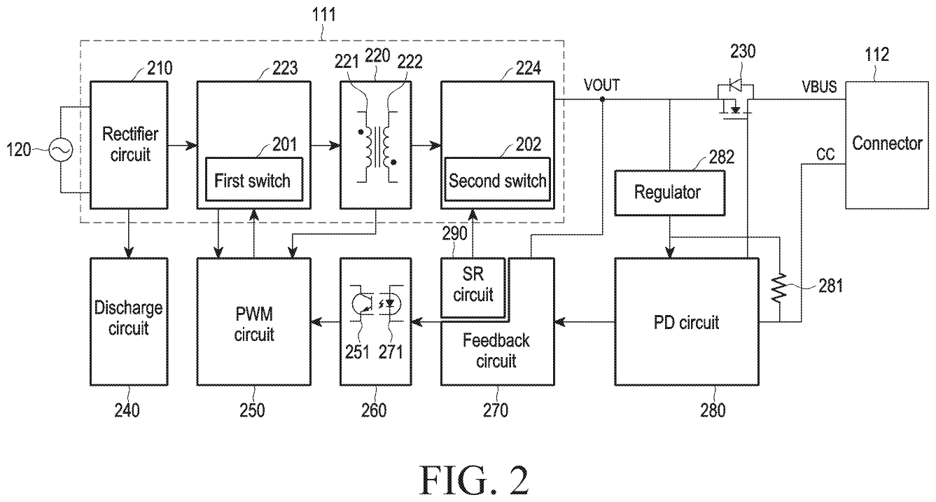

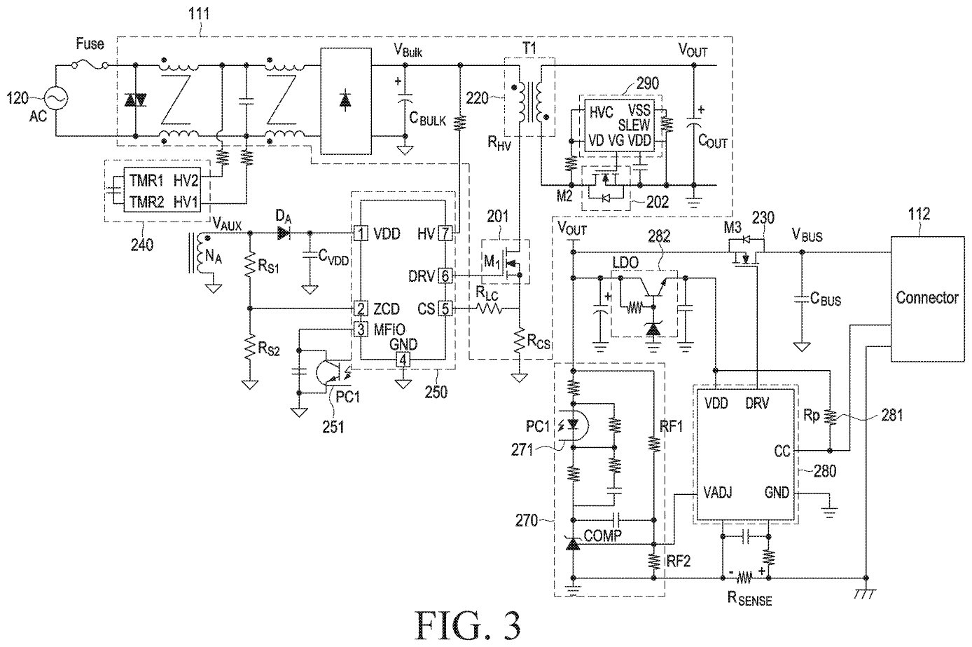

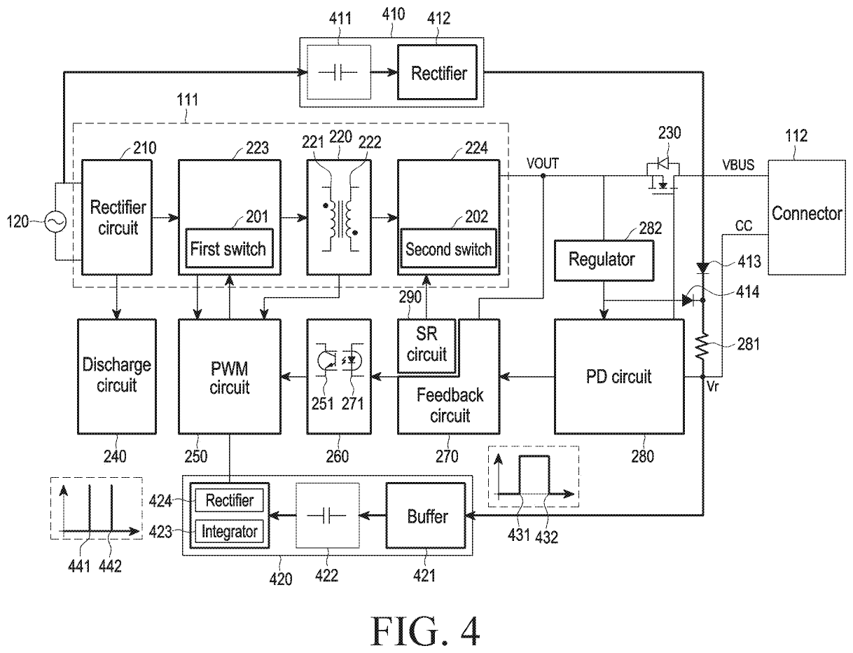

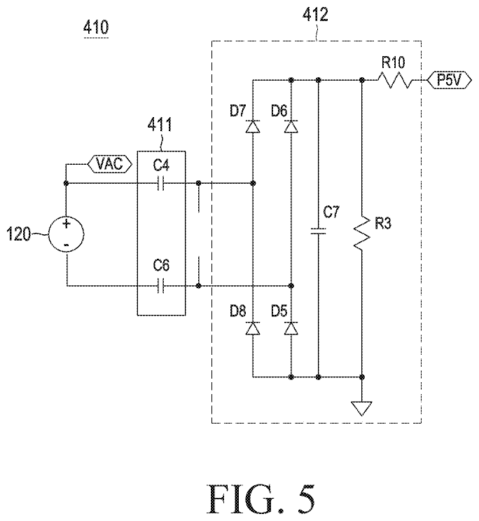

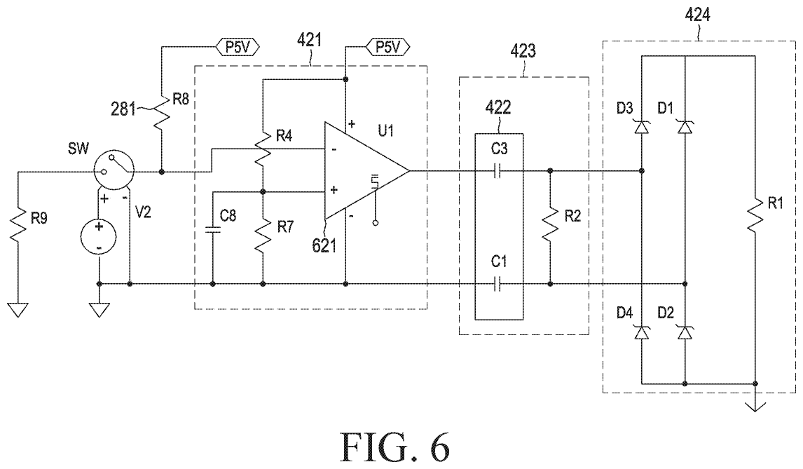

FIG. 2 is a block diagram illustrating an electronic device according to according to an embodiment of the disclosure. FIG. 3 is a circuit diagram illustrating an electronic device according to an embodiment of the disclosure. FIG. 4 is a block diagram illustrating an electronic device, according to an embodiment of the disclosure. FIG. 5 is a circuit diagram illustrating a first circuit for capacitor isolation according to an embodiment of the disclosure. FIG. 6 is a circuit diagram illustrating a second circuit for capacitor isolation according to an embodiment of the disclosure.

FIGS. 2 and 3 are views illustrating at least a portion of a configuration included in an electronic device 110 (e.g., a power supply (e.g., a Type-C power delivery (PD) adapter)) according to an embodiment. FIG. 2 is a block diagram, and FIG. 3 is a circuit diagram including circuits corresponding to the configurations disclosed in FIG. 2. For example, the electronic device 110 may include at least a portion of the configuration disclosed in FIGS. 2 and 3. For example, the electronic device 110 may include a portion of the configuration disclosed in FIGS. 2 and 3 and may not include the remaining portion. For example, the electronic device 110 may include all of the configuration disclosed in FIGS. 2 and 3. The circuit configuration disclosed in FIGS. 2 and 3 is merely an example, and there is no limitation on the circuit configuration included in the electronic device 110. FIG. 4 is a view illustrating the electronic device 110 according to an embodiment. FIG. 4 illustrates the configurations of FIG. 2 and additional configurations (e.g., 410, 411, 412, 413, 414, 420, 421, 422, 423, 424). FIG. 4 is illustrated as including all of the configuration of FIG. 2, but this is merely an example. For example, the electronic device 110 may not include at least a portion of the configuration disclosed in FIG. 4. For example, the electronic device 110 may include at least a portion of the configuration disclosed in FIGS. 2 and 3 and may include at least a portion of the configuration disclosed only in FIG. 4. For example, the electronic device 110 may not include at least a portion of the configurations disclosed only in FIG. 4 and not disclosed in FIGS. 2 and 3.

Referring to FIGS. 2 and 3, according to an embodiment of the disclosure, the power conversion circuit 111 of the electronic device 110 may include a rectifier circuit 210 and a transformer 220. The rectifier circuit 210 may rectify AC power provided from the external power source 120 to DC power. The rectifier circuit 210 may include an AC filter (e.g., a line filter for electromagnetic interference (EMI) enhancement) and a rectifier (e.g., a full wave rectifier). The rectifier circuit 210 may filter AC power provided from the external power source 120 using the AC filter. The rectifier circuit 210 may rectify the filtered AC power to DC power using the rectifier. FIG. 3 illustrates a circuit diagram illustrating the AC filter and rectifier of the rectifier circuit 210 included in the power conversion circuit 111, but this is merely an example. The rectifier circuit 210 may provide rectified power to the transformer 220 (e.g., a flyback converter).

According to an embodiment of the disclosure, the electronic device 110 may include a discharge circuit 240. The discharge circuit 240 may perform an operation of discharging a capacitor of the AC filter (e.g., a line filter for EMI enhancement) of the rectifier circuit 210 in a state in which the connection between the electronic device 110 and the external power source 120 is released (e.g., in a state in which power is not received from the external power source 120).

According to an embodiment of the disclosure, the transformer 220 (e.g., an isolated converter) may be implemented as a transformer 220 (e.g., T1 of FIG. 3) including a primary coil 221 and a secondary coil 222. The transformer 220 may convert power provided from the rectifier circuit 210 using the transformer. The power conversion circuit 111 may include circuit configurations 223 (e.g., a resistor, a capacitor, and/or a switch disclosed in FIG. 3) electrically connected to the primary coil 221 and circuit configurations 224 (e.g., a resistor, a capacitor, and/or a switch disclosed in FIG. 3) electrically connected to the secondary coil 222. For example, a first switch 201 (e.g., M1 of FIG. 3) may be included in the circuit configurations 223 electrically connected to the primary coil 221. For example, a second switch 202 (e.g., M2 of FIG. 3) may be included in the circuit configurations 224 electrically connected to the secondary coil 222. The transformer 220 may convert power based on an operation of the first switch 201 and/or the second switch 202. It may also be said that the first switch 201 and/or the second switch 202 are included in the transformer 220. The transformer 220 may provide converted power (e.g., VOUT). The transformer 220 may output DC power through a parallel diode rectification operation and an output capacitor smoothing operation of the second switch 202 (e.g., a sync switch) after an energy storage and release process of the transformer (e.g., an inductor transformer) by a power conversion switching operation of the first switch 201 (e.g., a main switch).

According to an embodiment of the disclosure, the electronic device 110 may include a pulse width modulation (PWM) circuit 250. The PWM circuit 250 may control PWM of the first switch 201 electrically connected to the primary coil 221 of the transformer 220.

According to an embodiment of the disclosure, the electronic device 110 may include a feedback circuit 270. The feedback circuit 270 may be electrically connected to the secondary coil 222 of the transformer 220. The feedback circuit 270 may include a photo diode 271. The photo diode 271 may be photo coupled (PC) 260 (e.g., PC1 of FIG. 3) with a transistor 251. The transistor 251 may receive an optical signal provided from the photo diode 271. The transistor 251 may be electrically connected to the PWM circuit 250. The feedback circuit 270 may provide an error signal to the PWM circuit 250. For example, the feedback circuit 270 may generate an error signal by amplifying a difference between an output voltage (e.g., VOUT) of the transformer 220 and a reference voltage. The feedback circuit 270 may provide the error signal to the PWM circuit 250 through the transistor 251 via the photo diode 271. The PWM circuit 250 may control a duty cycle of the first switch 201 based on the error signal provided from the feedback circuit 270. As a result, the output voltage (e.g., VOUT) of the transformer 220 may be regulated.

According to an embodiment of the disclosure, the electronic device 110 may include a synchronous rectifier (SR) circuit 290. The SR circuit 290 may control the second switch 202 to minimize a loss during conduction of a diode in a parallel connection structure of the second switch 202.

According to an embodiment of the disclosure, the electronic device 110 may include a third switch 230 (e.g., a load switch) between the power conversion circuit 111 and the connector 112. An output voltage of the power conversion circuit 111 may be provided to the external device 130 through the third switch 230 and the connector 112.

According to an embodiment of the disclosure, the electronic device 110 may include a power delivery (PD) circuit 280. The PD circuit 280 may control power provided to the external device 130. The PD circuit 280 may control the third switch 230. The PD circuit 280 may control the third switch 230 (e.g., a load switch) so that power is provided to the external device 130 based on the external device 130 being connected to the connector 112. The PD circuit 280 may control the power provided to the external device 130 through power data object (PDO) negotiation with the external device 130 (e.g., may increase the voltage of output power of the electronic device 110 to a rated voltage). For example, the PD circuit 280 may control the power provided to the external device 130 based on a voltage at one end of the resistor 281 electrically connected to the connector 112.

According to an embodiment of the disclosure, the electronic device 110 may include a regulator 282 (e.g., a low-dropout regulator (LDO), or a linear dropout regulator). The regulator 282 may provide the output voltage (e.g., VOUT) of the power conversion circuit 111 to the PD circuit 280.

Referring to FIGS. 2 and 3, according to an embodiment of the disclosure, the electronic device 110 may operate in a general low-power mode while connected to the external power source 120 and not connected to the external device 130. The general low-power mode may include (a) normal switching, (b) pulse skipping, or (c) burst switching. However, even when the electronic device 110 operates in the general low-power mode, standby power due to minimum circuit operation may be generated. Referring to FIG. 4, a circuit configuration and an operating method for reducing standby power using capacitor isolation may be described.

Referring to FIG. 4, according to an embodiment of the disclosure, the electronic device 110 may include a first circuit 410 configured to provide a bias voltage to a resistor 281 electrically connected to the connector 112. The first circuit 410 may supply a bias voltage to the resistor 281 electrically connected to the connector 112 based on power provided from the external power source 120. The first circuit 410 may include a first capacitor 411 for capacitor isolation and voltage distribution across two opposite ends of the first circuit 410. The first circuit 410 may include a first rectifier 412 configured to process AC power provided from the external power source 120. Referring to FIG. 5, a circuit of the first capacitor 411 (e.g., C4, C6 of FIG. 5) and the first rectifier 412 of the first circuit 410 may be understood. A bias voltage rectified in the first circuit 410 (e.g., a voltage provided to P5V of FIG. 5) may be provided to the resistor 281 electrically connected to the connector 112.

Referring to FIG. 4, according to an embodiment of the disclosure, the electronic device 110 may include a second circuit 420 configured to provide a signal to the PWM circuit 250 based on connection or disconnection to the external device 130 through the connector 112. The second circuit 420 may provide a signal to the PWM circuit 250 based on a signal corresponding to a voltage at one end of the resistor 281 electrically connected to the connector 112. The second circuit 420 may include a second capacitor 422 for capacitor isolation and voltage distribution across two opposite ends of the second circuit 420. The second circuit 420 may include a buffer 421 configured to receive a signal corresponding to a voltage at one end of the resistor 281 electrically connected to the connector 112. The second circuit 420 may include an integrator 423 configured to process a signal provided from the buffer 421 through the second capacitor 422. The second circuit 420 may include a second rectifier 424 configured to process a signal provided from the integrator 423.

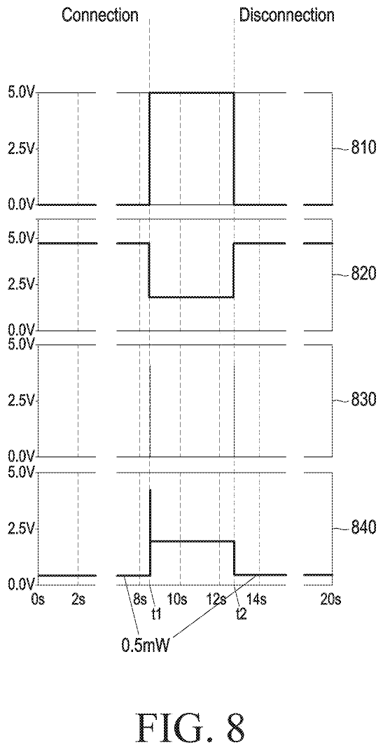

Referring to FIG. 6, a circuit of the buffer 421, the second capacitor 422 (e.g., C1, C3 of FIG. 6), the integrator 423, and the second rectifier 424 of the second circuit 420 may be understood. For example, the buffer 421 may include a comparator (e.g., an OP-amp 621). R9 of FIG. 6 may be a resistor of the external device 130. Based on the connection between the electronic device 110 and the external device 130 through the connector 112, a divided voltage between the resistor 281 (e.g., R8 of FIG. 6) of the electronic device 110 and the resistor (e.g., R9 of FIG. 6) of the external device 130 may be input to the comparator (e.g., the OP-amp 621), and the comparator (e.g., the OP-amp 621) may output a pulse signal while serving as a buffer. For example, the comparator (e.g., the OP-amp 621) may output a high signal based on the connection between the electronic device 110 and the external device 130 through the connector 112 and may output a low signal based on the disconnection between the electronic device 110 and the external device 130. The pulse signal of the comparator (e.g., the OP-amp 621) may be converted to positive and negative impulse signals by the integrator 423 (e.g., C1, C3, R2 of FIG. 6). The positive and negative impulse signals of the integrator 423 may be converted to a positive impulse signal by the second rectifier 424 (e.g., D1, D2, D3, D4 of FIG. 6). As a result, the second circuit 420 may provide an impulse signal (e.g., 830 of FIG. 8) synchronized with the connection or disconnection to the external device 130 through the connector 112 to the PWM circuit 250.

For example, referring to FIG. 4, when the electronic device 110 and the external device 130 are connected (e.g., at time 431 of FIG. 4), a first impulse signal 441 may be provided to the PWM circuit 250 through the second circuit 420 based on a signal corresponding to a voltage (e.g., Vr of FIG. 4) at one end of the resistor 281. The PWM circuit 250 may be activated based on the first impulse signal 441 and may provide a PWM signal to the first switch 201. The power conversion circuit 111 may operate based on the PWM signal provided to the first switch 201. When the connection between the electronic device 110 and the external device 130 is released (e.g., at time 432 of FIG. 4), a second impulse signal 442 may be provided to the PWM circuit 250 through the second circuit 420 based on a signal corresponding to the voltage (e.g., Vr of FIG. 4) at one end of the resistor 281. The PWM circuit 250 may be deactivated based on the second impulse signal 442 and may not provide a PWM signal to the first switch 201 (e.g., may stop providing the PWM signal). The power conversion circuit 111 may not operate based on the PWM signal not being provided to the first switch 201.

Referring to FIG. 4, according to an embodiment of the disclosure, the electronic device 110 may include a first diode 413 and a second diode 414. The first diode 413 may be electrically connected to the first circuit 410. The second diode 414 may be electrically connected to the regulator 282. A voltage may be provided to the resistor 281 through a connection structure of the first diode 413 and the second diode 414. For example, while the power conversion circuit 111 is operating (e.g., while the voltage of 5 V or more is output from the power conversion circuit 111), a voltage provided from the power conversion circuit 111 may be provided to the resistor 281 through the second diode 414, and while the power conversion circuit 111 is not operating (e.g., while no voltage is output from the power conversion circuit 111 or while a voltage less than 5 V is output), a voltage (e.g., the voltage of 5 V) provided from the first circuit 410 may be provided to the resistor 281 through the first diode 413.

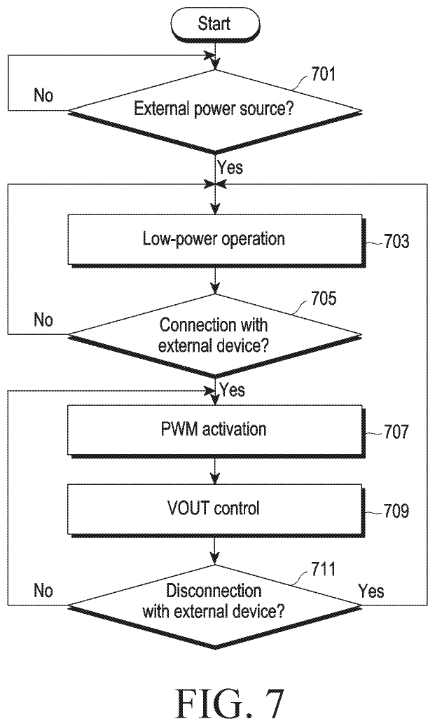

FIG. 7 is a flowchart illustrating an operating method of an electronic device according to an embodiment of the disclosure. FIG. 8 is a graph illustrating an operation of an electronic device according to an embodiment of the disclosure. FIG. 7 may be described with reference to previously described embodiments and embodiments to be described below.

At least a portion of the operations of FIG. 7 may be omitted. The operation order of the operations of FIG. 7 may be changed. At least two of the operations of FIG. 7 may be performed in parallel. Operations other than the operations of FIG. 7 may be performed before, while, or after performing the operations of FIG. 7.

Referring to FIG. 7, the operations of the power conversion circuit 111, the first circuit 410, and the second circuit 420 of the electronic device 110 may be described in a process in which the electronic device 110 is connected to the external power source 120 to receive power from the external power source 120 and the electronic device 110 is connected to the external device 130 to provide power to the external device 130.

Referring to FIG. 7, in operation 701, according to an embodiment of the disclosure, the electronic device 110 may identify whether the external power source 120 is connected. The electronic device 110 may receive AC power from the external power source 120.

In operation 703, according to an embodiment of the disclosure, the electronic device 110 may perform a low-power operation while connected to the external power source 120 and not connected to the external device 130. The low-power operation may be an operation of the first circuit 410. While the low-power operation is performed, the power conversion circuit 111 may not operate. For example, the electronic device 110 may provide a bias voltage to the resistor 281 electrically connected to the connector 112 using the first circuit 410 while connected to the external power source 120 and not connected to the external device 130. For example, while connected to the external power source 120 and not connected to the external device 130, the power conversion circuit 111 of the electronic device 110 may not operate.

In operation 705, according to an embodiment of the disclosure, the electronic device 110 may be connected to the external device 130 through the connector 112. When the electronic device 110 is not connected to the external device 130, the electronic device 110 may continue to perform the low-power operation of operation 703.

In operation 707, according to an embodiment of the disclosure, PWM may be activated based on the connection between the electronic device 110 and the external device 130 through the connector 112. PWM activation (enable) may be the PWM signal being transmitted from the PWM circuit 250 to the first switch 201. When a signal (e.g., the first impulse signal 441 of FIG. 4) is transmitted to the PWM circuit 250 through the second circuit 420, PWM may be activated and, when a signal (e.g., the first impulse signal 442 of FIG. 4) is transmitted to the PWM circuit 250 through the second circuit 420 again, PWM may be deactivated. PWM deactivation (disable) may be the PWM signal not being transmitted from the PWM circuit 250 to the first switch 201. When a signal is transmitted to the PWM circuit 250 through the second circuit 420 in the PWM deactivation state, PWM may be activated. When a signal is transmitted to the PWM circuit 250 through the second circuit 420 in the PWM activation state, PWM may be deactivated. For example, based on the connection between the electronic device 110 and the external device 130 through the connector 112, a signal (e.g., a first impulse signal) may be provided from the second circuit 420 to the PWM circuit 250. Based on the signal (e.g., the first impulse signal), a PWM signal may be transmitted from the PWM circuit 250 to the first switch 201. For example, based on the disconnection between the electronic device 110 and the external device 130, a signal (e.g., a second impulse signal) may be provided from the second circuit 420 to the PWM circuit 250. Based on the signal (e.g., the second impulse signal), a PWM signal may not be transmitted from the PWM circuit 250 to the first switch 201 (e.g., the transmission of the PWM signal may be stopped).

In operation 709, according to an embodiment of the disclosure, the electronic device 110 may control an output voltage (e.g., VOUT of FIG. 4) of the power conversion circuit 111 based on PWM activation. For example, the electronic device 110 may adjust the output voltage of the power conversion circuit 111 (e.g., may adjust the output voltage from 0 V to 5 V) as the PWM circuit 250 is activated through the second circuit 420 based on the connection between the electronic device 110 and the external device 130 through the connector 112. The output voltage (e.g., 5 V) of the power conversion circuit 111 may be provided to the PD circuit 280 through the regulator 282. The PD circuit 280 may control the third switch 230 to on so that power is provided to the external device 130 through the connector 112. The PD circuit 280 may control the power provided to the external device 130 through PDO negotiation with the external device 130 (e.g., may increase the voltage of output power of the electronic device 110 to a rated voltage).

In operation 711, according to an embodiment of the disclosure, PWM may be deactivated based on the disconnection between the electronic device 110 and the external device 130. The operation of the power conversion circuit 111 may be stopped based on the disconnection between the electronic device 110 and the external device 130.

For example, in FIG. 8, the electronic device 110 and the external device 130 may be connected at a first time (e.g., t1), and the connection between the electronic device 110 and the external device 130 may be released at a second time (e.g., t2). 810 of FIG. 8 may be the voltage of the resistor 281. 820 of FIG. 8 may be a bias voltage of the first circuit 410. 830 of FIG. 8 may be an impulse signal provided from the second circuit 420 to the PWM circuit 250. 840 of FIG. 8 may be power consumption of the electronic device 110. Referring to 840 of FIG. 8, it may be identified that standby power (e.g., power consumption while the connection between the electronic device 110 and the external device 130 is released) of the electronic device 110 including the first circuit 410 and the second circuit 420 is maintained at or below a reference power (e.g., 0.5 mW).

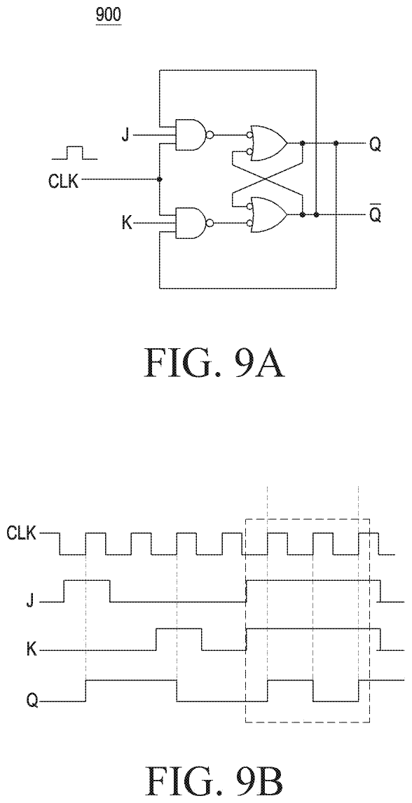

FIGS. 9A and 9B are views illustrating an operation 900 of an electronic device according to various embodiments of the disclosure.

According to an embodiment of the disclosure, the PWM circuit 250 may include logic corresponding to the JK flip-flop of FIG. 9A. In the operation of the JK flip-flop, when J=K=1 is fixed and the impulse signal of 830 of FIG. 8 (e.g., the impulse signal provided from the second circuit 420 to the PWM circuit 250) is input as the clock signal (e.g., CLK) of FIG. 9A, a pulse such as Q of FIG. 9B may be implemented by a positive edge clock. In other words, based on the detection of connection or disconnection of the external device 130, an On/Off pulse such as Q of FIG. 9B is implemented through the first circuit 410 and the second circuit 420 for capacitor isolation, so implementation of logic inside the PWM circuit 250 is possible.

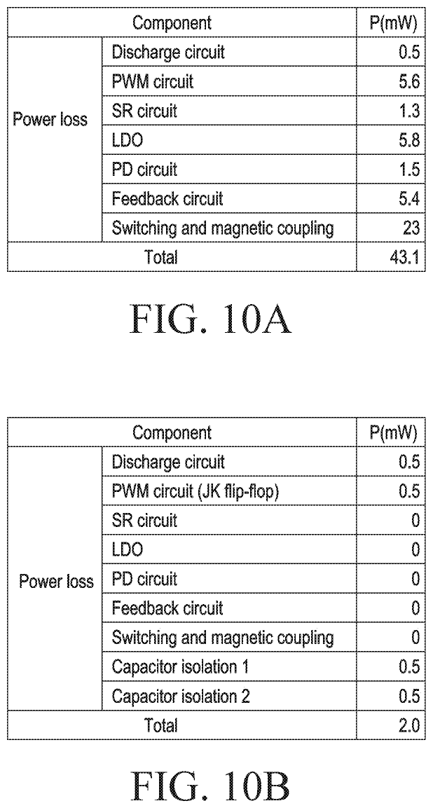

FIGS. 10A and 10B are views illustrating standby power of an electronic device according to various embodiments of the disclosure.

FIGS. 10A and 10B may be a power loss corresponding to the configuration of FIGS. 2 and 3. FIG. 10B may be a power loss corresponding to the configuration of FIG. 4.

In the embodiment of FIGS. 2 and 3, the total standby power of the electronic device 110 may be 43.1 mW, and in the embodiment of FIG. 4, the total standby power of the electronic device 110 may be 2 mW. The values are exemplary.

In FIG. 4, the standby power of the electronic device 110 may be decreased by the circuit configuration and operating method using capacitor isolation.

Those skilled in the art may understand that the embodiments described in this specification may be applied in combination with each other within an applicable range. For example, it will be understood by one of ordinary skill in the art that at least some operations of an embodiment described in the disclosure may be omitted and applied, or at least some operations of an embodiment may be interchangeably applied.

Technical objects to be achieved herein are not limited to the foregoing technical objects, and other technical objects not mentioned may be clearly understood by those skilled in the art from the following description.

Effects obtainable from the disclosure are not limited to the above-mentioned effects, and other effects not mentioned may be clearly understood by those skilled in the art from the following description.

According to an embodiment of the disclosure, the electronic device 110 may provide power to the external device 130. The electronic device 110 may include the power conversion circuit 111 configured to convert power provided from the external power source 120. The electronic device 110 may include the connector 112 configured to be connected to the external device 130 to provide power provided from the power conversion circuit 111 to the external device 130. The electronic device 110 may include the resistor 281 for detecting whether the external device 130 is connected through the connector 112. The electronic device 110 may include the first circuit 410 electrically connected to the first end of the resistor 281 to supply a bias voltage to the resistor 281 based on the power provided from the external power source 120. The electronic device 110 may include the PWM circuit 250 configured to control pulse width modulation (PWM) of the first switch 201 electrically connected to the primary coil 221 of the transformer 220 included in the power conversion circuit 111. The electronic device 110 may include the second circuit 420 electrically connected to the second end of the resistor 281 to provide a signal to the PWM circuit 250 based on connection or disconnection to the external device 130 through the connector 112. The first circuit 410 may include the first capacitor 411 for capacitor isolation and voltage distribution across two opposite ends of the first circuit 410. The second circuit 420 may include the second capacitor 422 for capacitor isolation and voltage distribution across two opposite ends of the second circuit 420.

According to an embodiment of the disclosure, the first circuit 410 may include the first rectifier 412 configured to process the power provided from the external power source 120.

According to an embodiment of the disclosure, the second circuit 420 may include the buffer 421 configured to receive a signal corresponding to a voltage at the second end of the resistor 281.

According to an embodiment of the disclosure, the buffer 421 may include the OP-amp 621.

According to an embodiment of the disclosure, the second circuit 420 may include the integrator 423 configured to process a signal provided from the buffer 421 through the second capacitor 422. The second circuit 420 may include the second rectifier 424 configured to process a signal provided from the integrator 423.

According to an embodiment of the disclosure, the second circuit 420 may be configured to provide a positive impulse signal output through the second rectifier 424 to the PWM circuit 250.

According to an embodiment of the disclosure, the second circuit 420 may be configured to provide a first impulse signal to the PWM circuit 250 based on a connection between the electronic device 110 and the external device 130 through the connector 112. The second circuit 420 may be configured to provide a second impulse signal to the PWM circuit 250 based on disconnection between the electronic device 110 and the external device 130.

According to an embodiment of the disclosure, the electronic device 110 may include the PD circuit 280 configured to control the power provided to the external device 130 based on a voltage at the second end of the resistor 281 electrically connected to the connector 112.

According to an embodiment of the disclosure, the power conversion circuit 111 may include the rectifier circuit 210 configured to rectify the power provided from the external power source 120. The power conversion circuit 111 may include the transformer 220 configured to convert power provided from the rectifier circuit 210. The transformer 220 may include the primary coil 221 and the secondary coil 222.

According to an embodiment of the disclosure, the electronic device 110 may include the feedback circuit 270 including the photo diode 271 and electrically connected to the secondary coil 222 of the transformer 220. The electronic device 110 may include the transistor 251 configured to operate by an optical signal from the photo diode 271 and electrically connected to the PWM circuit 250.

According to an embodiment of the disclosure, the electronic device 110 may include the discharge circuit 240 electrically connected to the rectifier circuit 210.

According to an embodiment of the disclosure, the electronic device 110 may include the SR circuit 290 configured to control the second switch 202 electrically connected to the secondary coil 222 of the transformer 220.

According to an embodiment of the disclosure, the electronic device 110 may include the regulator 282 electrically connected to the secondary coil 222 of the transformer 220 and configured to provide power to the PD circuit 280.

According to an embodiment of the disclosure, a method performed by the electronic device 110 providing power to the external device 130 may include supplying a bias voltage to the resistor 281 for detecting whether an external device 130 is connected through the connector 112 of the electronic device 110 using the first circuit 410 including the first capacitor 411 for capacitor isolation and voltage distribution based on receiving power from the external power source 120. The first circuit 410 may be electrically connected to a first end of the resistor 281. The method may include providing a signal to the PWM circuit 250 using the second circuit 420 including the second capacitor 422 for capacitor isolation and voltage distribution based on a connection between the electronic device 110 and the external device 130 through the connector 112. The second circuit 420 may be electrically connected to a second end of the resistor 281. The method may include controlling PWM of the first switch 201 electrically connected to the primary coil 221 of the transformer 220 included in the power conversion circuit 111 of the electronic device 110 using the PWM circuit 250 based on the signal provided from the second circuit 420. The method may include providing power provided from the power conversion circuit 111 to the external device 130 through the connector 112.

According to an embodiment of the disclosure, supplying the bias voltage may include rectifying the power from the external power source 120 using the first rectifier 412 of the first circuit 410.

According to an embodiment of the disclosure, providing the signal to the PWM circuit 250 using the second circuit 420 may include receiving a signal corresponding to a voltage at the second end of the resistor 281 using the buffer 421 of the second circuit 420.

According to an embodiment of the disclosure, providing the signal to the PWM circuit 250 using the second circuit 420 may include processing a signal provided from the buffer 421 through the second capacitor 422 using the integrator 423 of the second circuit 420. Providing the signal to the PWM circuit 250 using the second circuit 420 may include processing a signal provided from the integrator 423 using the second rectifier 424 of the second circuit 420.

According to an embodiment of the disclosure, providing the signal to the PWM circuit 250 using the second circuit 420 may include providing a first impulse signal to the PWM circuit 250 based on a connection between the electronic device 110 and the external device 130 through the connector 112. Providing the signal to the PWM circuit 250 using the second circuit 420 may include providing a second impulse signal to the PWM circuit 250 based on disconnection between the electronic device 110 and the external device 130.

According to an embodiment of the disclosure, providing the power provided from the power conversion circuit 111 to the external device 130 may include controlling the power provided to the external device 130 based on a voltage at the second end of the resistor 281 electrically connected to the connector 112.

According to an embodiment of the disclosure, providing the power provided from the power conversion circuit 111 to the external device 130 may include providing an optical signal to the transistor 251 electrically connected to the PWM circuit 250 using the photo diode 271 of the feedback circuit 270 electrically connected to the secondary coil 222 of the transformer 220 included in the power conversion circuit 111.

According to an embodiment of the disclosure, providing the power provided from the power conversion circuit 111 to the external device 130 may include controlling the second switch 202 electrically connected to the secondary coil 222 of the transformer 220.

The device according to various embodiments of the disclosure may be one of various types of electronic devices. The device may include, for example, a portable communication device (e.g., a smartphone), a computer device, a portable multimedia device, a portable medical device, a camera, a wearable device, or a home appliance. The devices according to an embodiment of the disclosure are not limited to the above-described devices.

The various embodiments of this document and the terms used herein are not intended to limit the technical features described in this document to specific embodiments of the disclosure, and should be understood to include various modifications, equivalents, or alternatives of the corresponding embodiments. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program) including one or more instructions that are stored in a storage medium that is readable by a machine (e.g., an electronic device). For example, a processor (e.g., a controller) of the machine may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities. Some of the plurality of entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device configured to provide power to an external device, the electronic device comprising:
a power conversion circuit configured to convert power provided from an external power source;
a connector configured to be connected to the external device to provide power provided from the power conversion circuit to the external device;
a resistor configured to detect whether the external device is connected through the connector;
a first circuit electrically connected to a first end of the resistor to supply a bias voltage to the resistor based on the power provided from the external power source;
a pulse width modulation (PWM) circuit configured to control PWM of a first switch electrically connected to a primary coil of a transformer included in the power conversion circuit; and
a second circuit electrically connected to a second end of the resistor to provide a signal to the PWM circuit based on connection or disconnection with the external device through the connector,
wherein the first circuit includes a first capacitor for capacitor isolation and voltage distribution at both ends of the first circuit, and the second circuit includes a second capacitor for capacitor isolation and voltage distribution at both ends of the second circuit.

2. The electronic device of claim 1, wherein the first circuit includes a first rectifier configured to process the power provided from the external power source.

3. The electronic device of claim 1, wherein the second circuit includes a buffer configured to receive a signal corresponding to a voltage at the second end of the resistor.

4. The electronic device of claim 3, wherein the second circuit includes:
an integrator configured to process a signal provided from the buffer through the second capacitor, and
a second rectifier configured to process a signal provided from the integrator.

5. The electronic device of claim 4, wherein the second circuit is configured to provide a positive impulse signal output through the second rectifier to the PWM circuit.

6. The electronic device of claim 5, wherein the second circuit is configured to:
provide a first impulse signal to the PWM circuit based on connection between the electronic device and the external device through the connector; and
provide a second impulse signal to the PWM circuit based on disconnection between the electronic device and the external device.

7. The electronic device of claim 1, further comprising a power delivery (PD) circuit configured to control the power provided to the external device based on a voltage at the second end of the resistor electrically connected to the connector.

8. The electronic device of claim 7,
wherein the power conversion circuit includes:
a rectification circuit configured to rectify the power provided from the external power source, and
the transformer configured to convert power provided from the rectification circuit, and
wherein the transformer includes the primary coil and a secondary coil.

9. The electronic device of claim 8, further comprising:
a feedback circuit including a photodiode and electrically connected to the secondary coil of the transformer; and
a transistor configured to operate by an optical signal from the photodiode and electrically connected to the PWM circuit.

10. The electronic device of claim 8, further comprising a discharge circuit electrically connected to the rectification circuit.

11. The electronic device of claim 8, further comprising a synchronous rectifier (SR) circuit configured to control a second switch electrically connected to the secondary coil of the transformer.

12. The electronic device of claim 8, further comprising a regulator electrically connected to the secondary coil of the transformer and configured to provide power to a power delivery (PD) circuit.

13. A method performed by an electronic device configured to provide power to an external device, the method comprising:
based on receiving power from an external power source, supplying, by the electronic device, a bias voltage to a resistor configured to detect whether an external device is connected through a connector of the electronic device using a first circuit including a first capacitor for capacitor isolation and voltage distribution, wherein the first circuit is electrically connected to a first end of the resistor;
based on a connection between the electronic device and the external device through the connector, providing, by the electronic device, a signal to a pulse width modulation (PWM) circuit using a second circuit including a second capacitor for capacitor isolation and voltage distribution, wherein the second circuit is electrically connected to a second end of the resistor;
based on the signal provided from the second circuit, controlling, by the electronic device, PWM of a first switch electrically connected to a primary coil of a transformer included in a power conversion circuit of the electronic device using the PWM circuit; and
providing, by the electronic device, power provided from the power conversion circuit to the external device through the connector.

14. The method of claim 13, wherein supplying the bias voltage includes rectifying the power from the external power source using a first rectifier of the first circuit.

15. The method of claim 13, wherein providing the signal to the PWM circuit using the second circuit includes receiving a signal corresponding to a voltage at the second end of the resistor using a buffer of the second circuit.

16. The method of claim 15, further comprising:
processing, by an integrator of the second circuit, a signal provided from the buffer through the second capacitor; and
processing, by a second rectifier of the second circuit, a signal provided from the integrator.

17. The method of claim 16, further comprising:
providing, by the second circuit, a positive impulse signal output through the second rectifier to the PWM circuit.

18. The method of claim 17, further comprising:
providing, by the second circuit, a first impulse signal to the PWM circuit based on connection between the electronic device and the external device through the connector; and
providing, by the second circuit, a second impulse signal to the PWM circuit based on disconnection between the electronic device and the external device.

19. One or more non-transitory computer-readable storage media storing one or more computer programs including computer-executable instructions that, when executed by one or more processors of an electronic device providing power to an external device individually or collectively, cause the electronic device to perform operations, the operations comprising:
based on receiving power from an external power source, supplying, by the electronic device, a bias voltage to a resistor configured to detect whether an external device is connected through a connector of the electronic device using a first circuit including a first capacitor for capacitor isolation and voltage distribution, wherein the first circuit is electrically connected to a first end of the resistor;
based on a connection between the electronic device and the external device through the connector, providing, by the electronic device, a signal to a pulse width modulation (PWM) circuit using a second circuit including a second capacitor for capacitor isolation and voltage distribution, wherein the second circuit is electrically connected to a second end of the resistor;
based on the signal provided from the second circuit, controlling, by the electronic device, PWM of a first switch electrically connected to a primary coil of a transformer included in a power conversion circuit of the electronic device using the PWM circuit; and
providing, by the electronic device, power provided from the power conversion circuit to the external device through the connector.

20. The one or more non-transitory computer-readable storage media of claim 19, wherein supplying the bias voltage includes rectifying the power from the external power source using a first rectifier of the first circuit.
